(19) United States
(12) Patent Application Publication
(10) Pub. No.: US 2010/0229728 A1
(43) Pub. Date: Sep. 16, 2010

(54) COFFEE MAKER

(76) Inventors: Alexander Kiefer, Kuchen (DE); Frank Goltenboth, Blaustein (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/722,039

(22) Filed: Mar. 11, 2010

(30) Foreign Application Priority Data
Mar. 12, 2009 (DE) DE102009012970.7

(51) Int. Cl. A47J 31/40; A47J 31/46

(52) U.S. Cl. 99/280; 99/302 R

(57) ABSTRACT

The present invention relates to a coffee maker with a brewing device connected to a water supply comprising a brewing chamber accommodating coffee powder and with a pump for feeding the brewing water into the brewing chamber. It is substantial to the invention that a control/regulating device is provided via which during the brewing process a brewing pressure acting on the coffee powder is adjustable.

The present invention relates to a coffee maker with a brewing unit connected to a water feed according to the preamble of claim 1.

From EP 0 427 666 B1 a generic coffee maker with a brewing unit connected to a water line is known, which comprises a brewing chamber accommodating coffee powder. In addition, the coffee maker comprises a pump for feeding the brewing water into the brewing chamber. Based on the realization that for the preparation of espresso on the one hand and the preparation of ordinary coffee on the other hand both the flow rate of the heated water per unit time as well as the temperature of the water under certain conditions have to be adjusted, EP 0 427 666 B1 proposes to positively assign a certain operating mode to a certain brewing device, for example a sieve or a filter so that with the same coffee maker using the same boiler and the same water delivery device both filter coffee can be produced according to the pressureless method as well as espresso according to the pressure method without the operating person having to manually adjust any operating parameters of the coffee maker.

From EP 1 902 653 A2 a generic coffee maker is likewise known wherein the power of the pump is designed for preparing an espresso. In addition to this, the generic coffee maker comprises devices or means for recording the backpressure acting against the hot water to be supplied to the brewing chamber through the coffee powder present in the brewing chamber. Accordingly, the known coffee maker is able to recognize a coffee powder present in the brewing chamber and as a function of the back pressure initiated by the coffee powder or its grinding fineness during the brewing process to draw a conclusion as to the coffee drink to be prepared and thus make possible automatic adaptation of the current brewing cycle to the requirements made for preparing the desired coffee drink.

The present invention deals with the problem of stating an improved or at least another embodiment for a generic coffee maker with which particularly tasty coffee drinks can be produced.

According to the invention, this problem is solved through the subject of the independent claim 1. Advantageous embodiments are the subject of the dependent claims.

The invention is based on the general idea of providing a control/regulating device with a coffee maker known per se with a brewing device connected to a water supply, e.g. from the drinking water network or an internal/external tank and a pump for feeding the brewing water into a brewing chamber, via which during the actual brewing process a brewing pressure acting on the coffee powder present in a brewing chamber is adjustable, that is more preferably, variable. For example for producing particularly tasty coffee drinks such as an espresso, it is an advantage if during a first brewing phase said espresso is prepared with a comparatively high brewing pressure while this is followed by a second brewing phase with a comparatively low brewing pressure. Through the comparatively high brewing pressure in the first brewing phase a high-quality crema can be offered wherein the full coffee aroma can fully develop through the brewing pressure which is reduced in the second brewing phase. Crema is the name for a dense golden brown froth which forms on the correctly prepared espresso and usually consists of oils, proteins and sugar types and forms a large part of the espresso aroma. With the control/regulating device according to the invention it is thus possible for the first time during the brewing process to vary, more preferably control or regulate the brewing pressure and thus generate an individually adapted brewing pressure.

With an advantageous further development of the solution according to the invention the control/regulating unit during the brewing process controls/regulates an output of the pump. Since the pump is responsible for supplying the water to the brewing chamber, the brewing pressure prevailing during the brewing process can be indirectly influenced via control or regulation of the pump output so that through the control/regulation of the pump output the brewing pressure can be particularly easily varied.

As an alternative to this it is also conceivable that the pump is always operated with the same pump output so that in this case the control/regulating device during the brewing process controls or regulates a bypass valve and thus influences the brewing pressure prevailing in the brewing chamber. Obviously the control/regulating device can also influence other components of the coffee maker which directly or indirectly influence the brewing pressure in the brewing chamber.

With a further advantageous embodiment of the solution according to the invention the control/regulating device is family of characteristics-controlled, wherein preferentially a plurality of drink-dependent families of characteristics for the control/regulation of the brewing pressure during the brewing process are present and more preferably stored in the control/regulating device. The respective families of characteristics can be more preferably adapted to the respective drink, for example a coffee or an espresso to be produced so that through the selection of the respective coffee drink the brewing pressure in the brewing chamber during the brewing process is already optimally adapted to the respective coffee drink desired. The families of characteristics can be experimentally determined in advance.

With a further advantageous embodiment of the solution according to the invention a flow monitoring device connected with the control/regulating device in a communicating manner is provided, which monitors a flow through the brewing device, wherein the control/regulating device controls/regulates the brewing pressure as a function of the flow. Because of this, a safety device can for example be created which during a severely rising brewing pressure within the brewing device, that is within the brewing chamber, attempts to reduce said brewing pressure in that for example the pump output is reduced by the control/regulating device. The opposite case is obviously likewise conceivable so that with a rising brewing pressure within the brewing chamber the output of the pump is increased in order for example to prevent clogging as far as possible.

Practically the control/regulating device controls/regulates the brewing pressure as a function of a set flow curve stored in a family of characteristics. It is thus also conceivable that as a function of the respective coffee drink selected set flow curves corresponding to this are stored in a family of characteristics so that for example when selecting an espresso the brewing pressure prevailing in the brewing chamber is regulated or controlled as a function of this set flow curve stored in the family of characteristics.

With the coffee maker according to the invention it is thus possible during the actual brewing process to directly or indirectly influence the brewing pressure prevailing in a brewing chamber and thus directly influence the respective coffee drink or espresso to be produced.

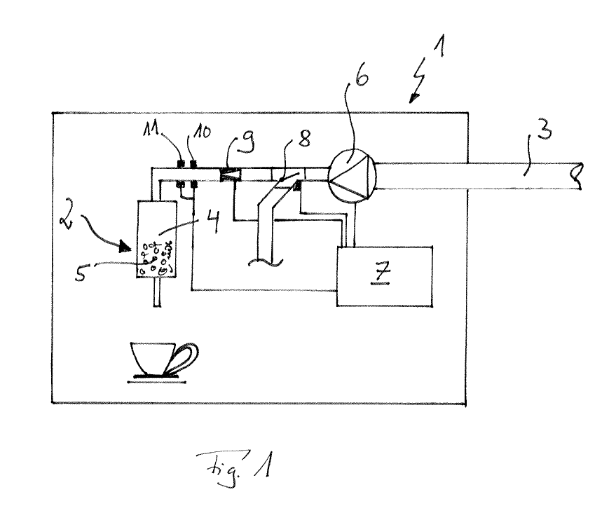

FIG. 1 shows a coffee maker according to the invention.

FIG. 1 shows a coffee maker 1 with a brewing device 2 connected to a water supply 3, which comprises a brewing chamber 4 accommodating coffee powder 5, an with a pump 6 for feeding the brewing water into the brewing chamber 4. The invention is, that a control/regulating device 7 is provided via which during the brewing process a brewing pressure acting on the coffee powder 5 is adjustable.

The control/regulating device 7 controls/regulates during the brewing process at least the pump 6. The control/regulating device 7 controls/regulates during the brewing process a bypass valve 8, and/or the control/regulating device 7 controls/regulates during the brewing process a throttling organ 9 located upstream of the brewing chamber 4

The control/regulating device 7 is family of characteristics-controlled, and/or the control/regulating device 7 a plurality of drink-based stores families of characteristics for the control/regulation of the brewing pressure during the brewing process.

The control/regulating device 7 holds the brewing pressure in a brewing phase higher than in another brewing phase for producing an espresso. At least one sensor 10 is provided, which is connected with the control/regulating device 7 in a communicating manner and which monitors at least one brewing parameter, preferably the flow wherein the control/regulating device 7 controls/regulates the brewing pressure as a function of at least this parameter. A flow monitoring device 11 is provided, which is connected with the control/regulating device 7 in a communicating manner and which monitors a flow through the brewing device 2, wherein the control/regulating device 7 controls/regulates the brewing pressure as a function of the flow. The control/regulating device 7 also controls/regulates the brewing pressure as a function of a set flow curve saved in a family of characteristics.

1. A coffee maker comprising:
a brewing device connected to a water supply; a brewing chamber configured to receive coffee powder;
a pump configured to feed the brewing water into the brewing chamber; and
a control device that adjustably regulates a brewing pressure.

2. The coffee maker according to claim 1, wherein the control device controls at least the pump during the brewing process.

3. The coffee maker according to claim 1, wherein the control device controls at least one of a bypass valve and a throttling organ located upstream of the brewing chamber.

4. The coffee maker according to claim 1, wherein the control device is specific to a family of drink parameters and regulates at least one parameter of flow and brewing pressure, based on a specific drink within the family of drink parameters.

5. The coffee maker according to claim 4, wherein the control device stores a plurality of parameters specific to drink-based families for the controlling brewing pressure during the brewing process.

6. The coffee maker according to claim 1, wherein the control device for producing an espresso holds the brewing pressure in a first brewing phase higher than at least one other brewing phase.

7. The coffee maker according to claim 1, wherein at least one sensor is in communication with the control device and monitors at least one brewing parameter.

8. The coffee maker according to claim 1, wherein a flow monitoring device is in communication with the control device, which monitors the flow through the brewing device, wherein the control device controls the brewing pressure as a function of the flow.

9. The coffee maker according to claim 8, wherein the control device controls the brewing pressure as a function of a set flow curve as a function of a stored family of drinks.

10. The coffee maker according to claim 2, wherein the control device controls at least one of a bypass valve and a throttling organ located upstream of the brewing chamber.

11. The coffee maker according to claim 2, wherein the control device is specific to a family of drink parameters and regulates at least one parameter of flow and brewing pressure, based on a specific drink within the family of drink parameters.

12. The coffee maker according to claim 3, wherein the control device is specific to a family of drink parameters and regulates at least one parameter of flow and brewing pressure, based on a specific drink within the family of drink parameters.

13. The coffee maker according to claim 2, wherein the control device for producing an espresso holds the brewing pressure in a first brewing phase higher than at least one other brewing phase.

14. The coffee maker according to claims 3, wherein the control device for producing an espresso holds the brewing pressure in a first brewing phase higher than at least one other brewing phase.

15. The coffee maker according to claims 4, wherein the control device for producing an espresso holds the brewing pressure in a first brewing phase higher than at least one other brewing phase.

16. The coffee maker according to claims 5, wherein the control device for producing an espresso holds the brewing pressure in a first brewing phase higher than at least one other brewing phase.

17. The coffee maker according to claim 2, wherein at least one sensor is in communication with the control device and monitors at least one brewing parameter.

18. The coffee maker according to claim 3, wherein at least one sensor is in communication with the control device and monitors at least one brewing parameter.

19. The coffee maker according to claim 4, wherein at least one sensor is in communication with the control device and monitors at least one brewing parameter.

20. The coffee maker according to claim 7, wherein the sensor monitors a fluid flow and the control device regulates the brewing pressure based on the flow.
